(19) United States
(12) Patent Application Publication
(10) Pub. No.: US 2023/0405517 A1
(43) Pub. Date: Dec. 21, 2023

(54) A SOLVENT SOLUTION AND PROCESS

(71) Applicant: KC8 CAPTURE TECHNOLOGIES LTD, Melbourne , Victoria (AU)

(72) Inventors: Barry Hooper, Melbourne, Victoria (AU); Geoffrey Stevens, Melbourne, Victoria (AU); Craig Osborne, Melbourne, Victoria (AU)

(21) Appl. No.: 18/026,159

(22) PCT Filed: Sep. 16, 2021
(86) PCT No.: PCT/AU2021/051070

§ 371 Date: Mar. 14, 2023

(30) Foreign Application Priority Data
Sep. 17, 2020 (AU) 2020903329

(51) Int. Cl. B01D 53/14; B01D 53/62; B01D 53/78; B01D 53/96; B01D 53/34; C01D 7/16; B01J 31/02

(52) U.S. Cl. CPC B01D 53/1493; B01D 53/1475; B01D 53/62; B01D 53/78; B01D 53/1425; B01D 53/96; B01D 53/1412; B01D 53/346; C01D 7/16; B01J 31/0237; B01J 31/0245; B01D 2257/504; B01D 2258/0283; B01D 2255/70; B01D 2252/602; B01D 2252/20494; B01D 2251/306; B01D 2251/304; B01J 2231/625

(57) ABSTRACT

An embodiment of the present invention relates to an aqueous solvent solution for absorbing carbon dioxide, and a process using an aqueous solvent solution for absorbing carbon dioxide. The aqueous solvent solution having a catalytic compound dissolved in the water that is an alkali salt of an N-substituted amino acid and at least one base that is dissolved in water. The catalytic compound assisting in forming a bicarbonate.

### FIELD OF THE PRESENT INVENTION

The present invention relates to an aqueous solvent solution for absorbing carbon dioxide. The present invention also relates to a process for absorbing carbon dioxide. The carbon dioxide may be absorbed from any gas stream including but by no means limited to, a pre-combustion gas stream such as a natural gas stream, a syngas stream that is either pre-combustion or post combustion, and a post-combustion gas stream such a flue gas stream.

### BACKGROUND OF THE PRESENT INVENTION

The capture of carbon dioxide from industrial gas streams, such as flue gas streams has been the focus of technical developments and is required to allow the fossil fuel resources to be used in the foreseeable future whilst meeting greenhouse gas emission targets. Chemical absorbents such as monoethanolamine (MEA) and diethanolamine (DEA), both of which are known as amine absorbents, have been used successfully because they have relative high reaction kinetics. The application of solvents is in a closed loop absorption-desorption system where carbon dioxide is first absorbed into the solvent followed by desorption and purification to provide a regenerated solvent solution. The regenerated solvent is then recycled back to the absorber for further absorption. A disadvantage of amine absorbents is that they can be susceptible to various forms of degradation, such as temperature and oxidative degradation. Alternative absorbents such as potassium carbonate are more tolerant to high temperatures but have the disadvantage of relatively low reaction kinetics. This has spawned an interest in adding promoters to carbonate solvents. Amines including MEA and DEA can be used as promoters in carbonate solvent solutions, however, the energy requirements to regenerate the solvent when loaded with carbon dioxide is still relatively high due to the formation of stable carbamates groups on the amine absorbents.

An object is to provide an alternative absorbent solvent and a process for absorbing carbon dioxide.

### SUMMARY OF THE PRESENT INVENTION

An embodiment of the present invention relates to an aqueous solvent solution that absorbs carbon dioxide and produces a bicarbonate, in which the solvent solution includes:
i) at least one base that is dissolved in water; and
ii) a catalytic compound dissolved in the water, wherein the catalytic compound is an alkali salt of an N-substituted amino acid (hereafter referred to as the amino acid derivative) that reacts with carbon dioxide to form a catalytic intermediate having a carbamate group, and the catalytic intermediate reacts with the base which deprotonates the carbamate group and undergoes hydrolysis which yields a bicarbonate precipitant.

That is to say, the base deprotonating the carbamate of the intermediate catalyst and which then undergoes hydrolysis to hydrolyse the carbonate group, which yields bicarbonate and reforms the catalytic compound.

The base may be at a high concentration in the aqueous solution so that the bicarbonate precipitates as a salt with the base.

The catalytic compound can remain in solution and separate from the precipitate.

Another embodiment of the present invention relates to an aqueous solvent solution that absorbs carbon dioxide and produces a bicarbonate, in which the solvent solution includes:
i) at least one base that is dissolved in water;
ii) a catalytic compound dissolved in the water, wherein the catalytic compound is an alkali salt of an N-substituted amino acid, capable of forming an unstable carbamate that reacts with carbon dioxide to form an intermediate catalyst having a carbamate group which then reacts with the base deprotonating the carbamate of the intermediate catalyst and which then undergoes hydrolysis to hydrolyse the carbonate group, yielding bicarbonate and reforming the catalytic compound; and
iii) wherein the base is at a high concentration in the aqueous solution so that the bicarbonate precipitates as a salt with the base.

We have found that the when the reaction between certain amino acid derivatives and carbon dioxide forms an intermediate catalyst having a carbamate in the presence of a base, the carbamate is deprotonated, following which hydrolysis of the compound drives off a carbonate in the form of bicarbonate and the amino acid derivative is protonated. In other words, we have found that such compounds behave catalytically in the true sense such that they can be used repeatedly in this cycle and within the absorption mixture thus maintaining high rates of absorption as the mixture becomes loaded with carbon dioxide.

One of the advantages of the solvent solution is that little or no heating is required to regenerate the amino acid derivative in this cycle and during the regeneration of the solvent solution.

### DETAILED DESCRIPTION

According to one example, the basic form of the amino acid salt derivative may have the general formula:

M⁺⁻OOC(CHR²)HNR¹ (Formula 1)
wherein R¹ is a group having at least one C atom,
R² is H or a group having at least one C atom, and
M⁺ is an alkali metal.
   Formula 1 includes both stereoisomer forms, and is not limited to the biologically active D-enantiomer. Subsequent references that use conventional amino acid names should not be taken to be referring only to the single isomer.

In one example, the catalytic compound is N-alkyl amino acid, where R¹ is an alkyl group and R² is any group having at least one C atom.

In one example, the catalytic compound is N-methyl amino acid, where R¹ is a methyl group and R² is any group having at least one C atom.

In one example, R¹ may be a methyl group and R² is H, the catalytic compound is N-methyl glycine, which is also known as sarcosine.

In another example, R¹ may be an alkyl group such as a butyl group and R² is H, the catalytic compound is a form of N-butyl glycine, such as N-sec butyl glycine.

The amino acid may also be any suitable amino acid derivative in which R² is a group including at least one C atom.

In yet another example, the catalytic compound is N-methyl alanine, in which R² may be a methyl group and R¹ is a methyl group.

In yet another example, the catalytic compound is n-methyl serine, in which R² may be a methyl group and R¹ may include a methyl hydroxyl (MeOH) group.

Without wanting to be limited by theory, when R¹ produces a secondary amine, including R¹ being a methyl group or any alkyl group, we believe that the secondary amine affects the relative stability of the carbamate group formed on absorption with carbon dioxide. For instance, if the amino acid derivative is a secondary amine, such as sarcosine, the carbamate group appears to be relatively less stable compared to a carbamate group formed on a primary amine, such as unsubstituted glycine. By reducing the stability of the carbamate group by structures such as n-sec methyl amino acids or n-sec alkyl amino acid derivative, the rate of the hydrolysis step proceeds readily. We believe the rate of the hydrolysis step is further enhanced through high base concentration and furthermore where bicarbonate species are precipitated. In other words, the solvent solution can react catalytically with little or no appreciable depletion of the active amino acid derivative species from the solvent solution, producing sustained rates of carbon dioxide absorption greater than that of the conventional uncatalyzed carbonate solvent. These conditions are produced with concentrated carbonate solutions and with certain amino acid derivative species. Amino acid derivative without the stated characteristics that produce stable carbamates have been shown not to act catalytically and are merely consumed to produce stoichiometric carbamates and require separate regeneration to regain high carbon dioxide absorption rates.

Examples of possible amino acids that can be appropriately substituted as per Formula 1 to form catalytic amino acid derivatives include: i) Glycine, ii) Alanine, and iii) Serine.

The structure of a range of amino acids, in their zwitterionic form, are depicted below in Table 1 in which R² takes the form as shown, including cyclical forms. In addition, for the amino acid to form part of the catalytic compound, it is envisaged that one of the hydrogen atoms attached to the nitrogen, will be substituted with R¹ as per Formula 1.

TABLE 1

| | |
|---|---|
| Glycine (Gly) | Alanine (Ala) |
| 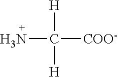 | 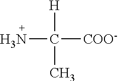 |
| Vlaine (Val) | Leucine (Leu) |
| 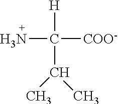 | 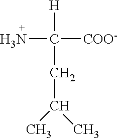 |
| Isoleucine (Ile) | Proline (Pro) |
| 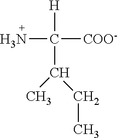 | 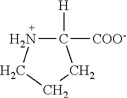 |
| Serine (Ser) | Threonine (Thr) |
| 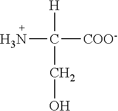 | 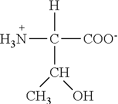 |
| Cysteine (Cys) | Methionine (Met) |
| 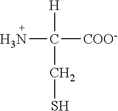 | 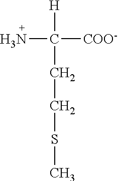 |
| Asparaagine (Asn) | Glutamine (Gln) |
| 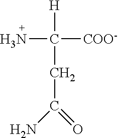 | 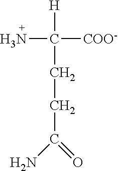 |
| Phenylalanine (Phe) | Tyrosine (Tyr) |
| 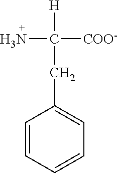 | 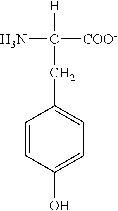 |
| Tryptophan (Trp) | Lysine (Lys) |
| 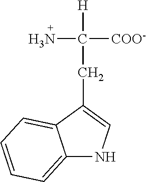 | 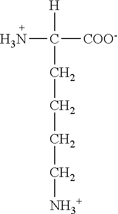 |
| Arginine (Arg) | Histidine (His) |
| 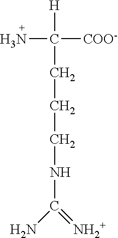 | 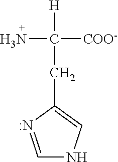 |
| Aspartate (Asp) | Glutamate (Glu) |
| 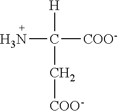 | 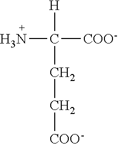 |

Preferably, the catalytic compound is in its basic amino acid derivative salt form through reaction with a suitable inorganic base. The inorganic base may be any suitable alkali. The alkali may, for example, be potassium. In another example, the alkali may be sodium.

The at least one base dissolved in water may be an alkali of varying levels of carbonation which is also referred to as loading. The alkali may be a metal alkali. Example include KOH having a zero level of carbonation, K₂CO₃ having a 2:1 ratio of carbonation, and KHCO₃ having a 1:1 ratio of carbonation. Increasing levels of carbonation are said to move from lean (low) loadings to rich (high) loadings.

Throughout this specification, references to the “loading”, “loading of the absorbent”, or variations thereof, refers to the molar proportion of the targeted species into the absorbent stream on a scale of 0-1, where the loading a totally regenerated stream is zero and loading of a totally loaded stream is 1. By way of example, when the targeted species is CO₂ and the absorbent is alkali carbonate, the loading of CO₂ incorporated into the alkali carbonate/alkali bicarbonate mixture, a loading of zero represents a solution containing only alkali carbonate and the loading of a solution containing only alkali bicarbonate is 1. In this example, the loading is equivalent to moles of CO₂ absorbed per mole of K₂CO₃.

Preferably the base dissolved in the water is the carbonate form of potassium or sodium.

The dissociation of carbonate in water may be represented as

H₂O+CO₃²⁻ [symbol] HCO₃⁻+OH⁻ (Eq. 1)

The catalytic intermediate includes a zwitterion compound.

The solvent solution may have any suitable pH in the alkaline range. For example, a pH greater than 8.0 and suitably greater than 9.0, and suitably greater than 9.5. Ideally, the pH is in the range of 9.5 to 13.5 and suitably in the range of 9.5 to 12.5, 11.5 or 11.0. However, it will be appreciated that the pH of the solvent solution can fluctuate and be controlled, for the most part, by altering the loading of the solvent solution through desorption of carbon dioxide.

The pH of the solvent solution may be controlled by monitoring the alkalinity of the solvent solution and adding a base when required. The base may, for example, be an alkali metal.

Ideally the solvent solution has a carbonate at a high concentration. In the case of potassium carbonate this will be in the range of 10 to 80 wt %, suitably 20 to 70 wt %, and suitably 30 to 60 wt %.

### Examples

Example One: A catalytic mechanism in which the catalytic compound is an amino acid that has been N substituted with a moiety including at least on carbon atom, the alpha carbon side-group differentiating the amino acid type. The catalytic mechanism is graphically represented as follows.

TABLE 1

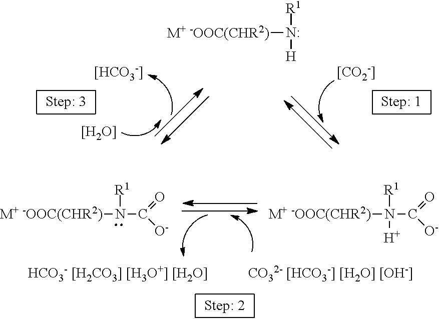

wherein R¹ is a group containing at least one C atom and
R² is H or a group containing at least one C atom.
M⁺ is an alkali metal

The catalytic compound is an anionic salt of a suitably N-substituted amino acid derivative. The amino acid derivative reacts with carbon dioxide in step 1 to form a carbamate group represented as (N—COO⁻) on a catalytic intermediate. In step 2 the catalytic intermediate is deprotonated by a base, which can be any of the bases present, namely carbonate, bicarbonate, water or hydroxide, all of which are present in the absorbent mixture to some degree. Each of these bases forms the respective protonated species shown in the diagram, including hydroxide to water, water to hydronium, carbonate to bicarbonate, bicarbonate to carbonic acid. Strong concentrations of carbonate support the use of the carbonate to bicarbonate deprotonation pathway enabling the intermediate catalytic compound to be hydrolysed in step 3. The use of high solvent concentrations, the use of catalytic compounds with unstable carbamates and allowing precipitation of the bicarbonate further enhances the hydrolysis pathway. This drives off bicarbonate and protonates the amino acid to complete the catalytic cycle of the compound and maintain high rates of carbon dioxide absorption as the solvent becomes loaded with carbon dioxide in the form of bicarbonate. Steps 2 and 3 both produce bicarbonate which is precipitated, suitably as an alkali bicarbonate.

Example Two: A catalytic mechanism in which the catalytic compound is a basic amino acid salt of N-methyl glycine.

TABLE 2

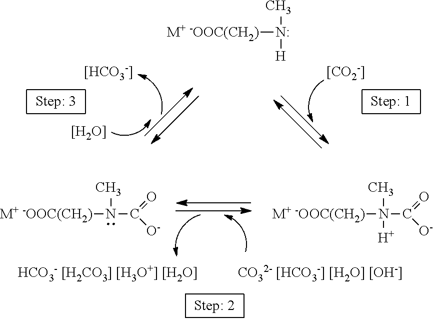

wherein M⁺ is an alkali metal.

The catalytic compound is a basic salt of an amino acid derivative. The amino group reacts with carbon dioxide in step 1 to form a carbamate group represented as (N—COO⁻) on a catalytic intermediate. The methyl group of the amino acid derivative is believed to destabilise the positive charge of the catalytic intermediate allowing rapid deprotonation and hydrolysis. In step 2 the catalytic intermediate is deprotonated by a base, which can be any of the bases present, namely carbonate, bicarbonate, water or hydroxide, all of which are present in the absorbent mixture to some degree. Each of these bases forms the respective protonated species shown in the diagram, including hydroxide to water, water to hydronium, carbonate to bicarbonate, bicarbonate to carbonic acid. Strong concentrations of carbonate support the use of the carbonate to bicarbonate deprotonation pathway enabling the catalytic intermediate to be hydrolysed in step 3. The precipitation of the bicarbonate further enhances the hydrolysis pathway. This drives off bicarbonate and protonates the amino acid derivative to complete the catalytic cycle and maintain high rates of carbon dioxide absorption as the solvent becomes loaded with carbon dioxide in the form of bicarbonate. Steps 2 and 3 both produce bicarbonate which is precipitated, suitably as an alkali bicarbonate.

We have found that basic amino acid salts without the substituted characteristics of this invention, such as glycine do not exhibit catalytic behaviour that we found in our experiments.

### BRIEF DESCRIPTION OF THE DRAWINGS

FIG. 1 is a graph illustrating trial results in which a potassium carbonate solvent solution having a N-methyl glycine catalytic compound is compared against an unpromoted solvent and two other promoters, namely basic forms of both boric acid and glycine.

FIG. 2 is a block diagram illustrating a preferred embodiment of process steps for absorbing carbon dioxide from a gas stream.

### PROCESS

The present invention also relates to a process of absorbing carbon dioxide from a gas stream, the process includes:
i) an absorbing step, in which the gas stream and the solvent solution, as described herein contact in an absorber vessel so that carbon dioxide in the gas stream reacts with the amino acid derivative of the solvent solution and adds a carbonate group to the amino group of the amino acid derivative to form a catalytic intermediate having a carbamate, wherein the absorbing step is carried out under alkaline conditions so that the catalytic intermediate deprotonates and the carbamate group undergoes hydrolysis which produces a bicarbonate and regenerates the amino acid derivative; and
ii) a precipitating step, in which the bicarbonate precipitates as an alkali bicarbonate precipitant.

The present invention also relates to a process of absorbing carbon dioxide from a gas stream, the process includes:
i) an absorbing step, in which the gas stream is contacted with a solvent solution including at least one base that is dissolved in water; and a catalytic compound dissolved in the water, wherein the catalytic compound is an alkali salt of an N-substituted amino acid that reacts with carbon dioxide to form a catalytic intermediate having a carbamate group, wherein the absorbing step is carried out under alkaline conditions so that the catalytic intermediate deprotonates and the carbamate group undergoes hydrolysis which produces a bicarbonate and regenerates the amino acid derivative; and
ii) a precipitating step, in which the bicarbonate precipitates as an alkali bicarbonate precipitant.

That is to say, the base deprotonating the carbamate of the intermediate catalyst and which then undergoes hydrolysis to hydrolyse the carbonate group, yielding bicarbonate and reforming the catalytic compound.

The base may be at a high concentration in the aqueous solution so that the bicarbonate precipitates as a salt with the base.

As described above in Examples One and Two, the deprotonation of the amino group and hydrolysis of the carbamate in reaction steps 2 and 3 both produce bicarbonate.

It will be appreciated that two or more of the steps of the process may be carried out simultaneously. For example, the absorbing step and the precipitating step may occur simultaneously or substantially simultaneously when the solvent solution contacts the gas stream in alkaline conditions.

The absorbing step and the precipitating step may be carried out simultaneously within the absorber vessel.

When the absorbing step and the precipitating step occur simultaneously, the steps may occur in two or more separate stages within the absorber vessel.

The absorbing step may be carried in multiple absorber vessels arranged in parallel. The number of absorber vessels will be a function of the volumetric flow of the gas stream to be treated.

Two or more of the steps of the process may be carried consecutively or disjunctively. When steps of the process are carried out consecutively or disjunctively, there may or may not be pauses in between the steps. For example, the separating step may be carried out after the precipitating step.

The process may include a temperature control step that includes heating the solvent solution. Heating the solvent solution may provide an activation energy for any one of the reaction steps, namely Steps 1, 2 or 3 as outlined in Examples One and Two.

The temperature control step may include cooling the solvent solution during the absorbing step. We have found that the heat of absorption of the carbon dioxide, and the heat of precipitation of bicarbonate can provide a temperature rise which can detrimentally affect the amount of acid gas absorption due to temperature driven mass transfer effects.

The temperature control step may include cooling the solvent solution to reduce the solubility of the alkali bicarbonate in the precipitating step.

The temperature control step may be carried out with the solvent solution in situ in an absorbing vessel, that is during the absorbing step. That is, heat transfer cooling surfaces may be provided in the absorbing vessel.

The temperature control step may include withdrawing a side-stream of the solvent solution from absorbing step, cooling the side stream, and returning the side-stream back to the absorbing step.

The process may include providing the solvent solution with adequate base to deprotonate the amino acid derivative.

The process may include monitoring the pH of the solvent solution at a level greater than 8.0, and suitably greater than 9.0 and suitably in a pH range of 9.5 to 13.5. The step of monitoring the pH may include adding carbonate or hydroxide to the solvent solution. The carbonate can disassociate in water in accordance with Equation 1 mentioned above.

That is to say, the process may include monitoring the pH of the solvent solution throughout the process at a level greater than 8.0, and suitably greater than 9.0 and suitably greater than 9.5. Ideally, the pH is in the range of 9.5 to 13.5 and suitably in the range of 9.5 to 12.5, 11.5 or 11.0.

The process may include a separating step, in which the alkali bicarbonate precipitant is separated from the solvent solution and recycling the solvent solution back to the absorbing step.

The separating step may be carried out in a hydro-cyclone.

The process may include adding an alkali salt to the solvent solution when an alkali bicarbonate precipitant is separated from the solvent solution. Adding the alkali salt can assist in keeping the pH of the solvent solution in the desired alkaline range. The alkali salt may be any suitable salt such as potassium carbonate.

The separation step may include decanting the solvent solution from the alkali bicarbonate precipitant. The decanting may be carried out in a settling zone. The settling zone may be in the absorber vessel, or a separate vessel. In event, it will be appreciated that the precipitant, although separated from the solvent solution, may be wet or include entrained solvent solution.

The process may also have a desorbing step which in at least a portion of the solvent solution containing absorbed carbon dioxide is heated to evolve a carbon dioxide gas from the solvent solution and to provide a lean solvent solution. The process may then include recycling the lean solvent solution to the absorbing step. That is to say, the process may have a closed loop of absorbing and desorbing whereby lean solvent solution absorbs carbon dioxide from the gas stream loading the solvent with said carbon dioxide to produce a rich solvent stream in the absorbing step. The rich stream is then sent to a desorption vessel (often referred to as a stripper) where the rich solvent is heated and evolves concentrated carbon dioxide and a solvent solution that is lean in carbon dioxide in the desorbing step. The lean solvent solution is then recycled to the absorbing step thus closing the solvent loop and continuing the removal of the carbon dioxide using the same inventory of solvent.

The desorbing step may convert alkali bicarbonate to alkali carbonate using a heat source which forms a gas stream rich in carbon dioxide. The desorbing step may be carried out using any heat source. For example, the heat source may be surplus heat of a power plant, iron smelter, cement plant and so forth. In the case of a power plant, the heat source may be a steam withdrawn from the stages of the power generating turbines or boiler house. However, in order not to interrupt the normal and optimal operating procedures of a power plant, suitably an auxiliary heating source may be used for heating and regenerating the bicarbonate. For example, the auxiliary heating source may involve the combustion of fossil fuels and in this situation, any flue gas produced by the auxiliary heating source may form part of the gas stream contacted with the solvent solution in the absorbing step.

In one embodiment, the desorbing step may be carried out on the solvent solution after the separating step.

In another embodiment, the desorbing step may be carried out on the solvent solution before the separating step.

The process may also include suitably storing bicarbonate precipitant prior to subsequent regeneration either i) in a slurry form, or ii) when separated.

### Post Combustion or Other Low Pressure Gas Streams

In the case where the gas stream is a post combustion gas stream, such as low pressure flue gas from a power station, the gas stream can be at high temperature but is likely to range from 50 to 80° C. and the temperature profile of a contactor vessel in which the absorber vessel is carried out ranges from 40 to 95° C. A benefit provided by this aspect is that the non-volatile and thermally stable solvent confers no constraint on the gas stream feed temperature providing one less constraint to the process designers. The solvent solution stream and the solvent sub-streams fed to the absorber vessel(s) may have a temperature ranging from 40 to 90° C., and suitably from 50 to 60° C. The process may include controlling the temperature of the absorbing step to a temperature ranging from 40 to 90° C.

The absorbing step may be is carried out at any pressure including pressures ranging from 100 to 1000 kPa absolute, 100 to 500 kPa, 100 to 300 kPa, and suitably from 100 to 200 kPa, or from 100 kPa to 150 kPa absolute.

The desorbing step can be performed at a pressure in the range from 30 to 600 kPa (absolute) and at temperatures ranging from 70 to 170° C.

The process may include controlling the temperature of the desorbing step to a temperature ranging from 70 to 160° C., and suitably ranging from 70 to 150° C., and suitably ranging from 70 to 110° C.

### Pre-Combustion or Other High Pressure Acid Gas Streams

In the case where the gas stream is a high pressure gas stream including, but not limited to, a pre-combustion gas stream such as a synthesis gas stream produced as the result of coal gasification or a natural gas stream, the temperature of the gas stream may vary widely.

The absorbing step may be carried out at a pressure ranging from 1,000 to 8,000 kPa absolute, and suitably at a pressure ranging from 2,500 to 6,500 kPa absolute.

The process may include controlling the temperature of the absorbing step to a temperature ranging from 40 to 90° C. The process may also include controlling the temperature of the desorbing step to a temperature ranging from 70 to 160° C., and suitably from ranging from 70 to 150° C., and suitably ranging from 70 to 110° C.

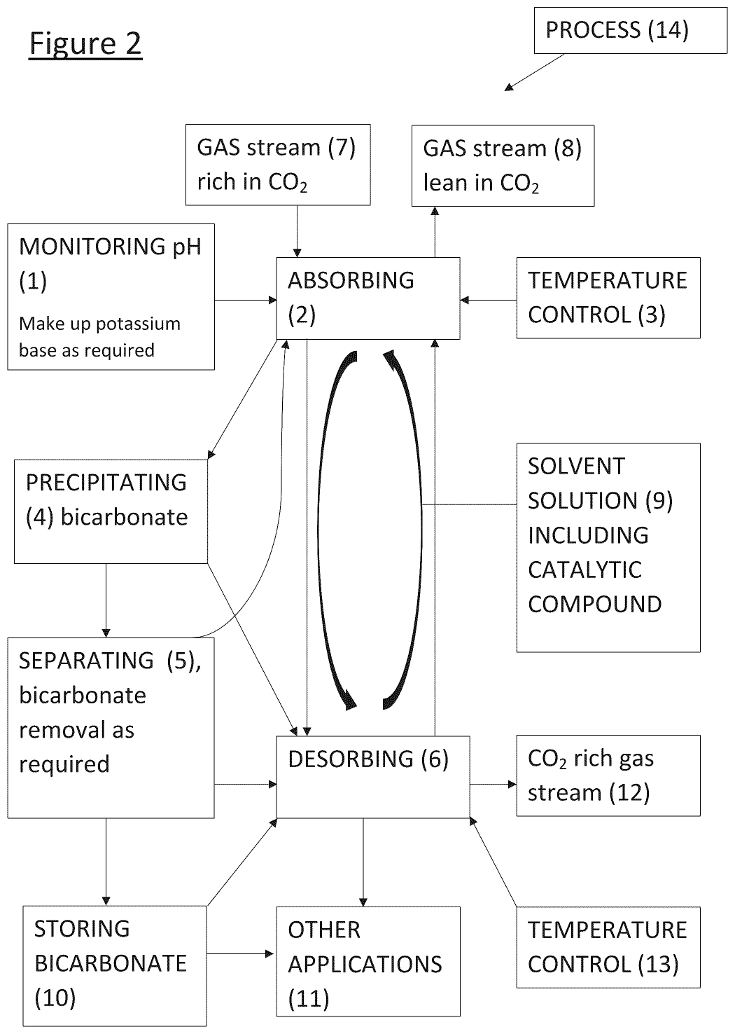

### Description of FIG. 2

With reference to FIG. 2, a preferred embodiment of the process (14) includes an absorbing step (2) in which the solvent solution (9) is used to absorb carbon dioxide from a gas stream (7) rich in carbon dioxide, and discharges as gas stream (8) lean in carbon dioxide. The solvent solution (9) will include the catalytic compound described herein to promote the absorption of carbon dioxide. The gas stream (7) can be any gas type including a pre-combustion gas stream such as a natural gas stream, a syngas stream that is either pre-combustion or post combustion, or a post-combustion gas stream such as a flue gas. The gas stream (7) may also be a blended stream of multiple gas types and may be at any pressure and temperature. For example, the gas stream (7) can be at a high pressure and high temperature, such as up to 8,000 kPa absolute and up to 700° C. In another example, the gas stream (7) can be at a low pressure and temperature, such as at a pressure from 100 kPa and a temperature from 40° C. The gas stream (7) can be at any pressure and temperature therebetween these values.

The process (14) has a pH control step (1) in which the alkalinity of the absorbing step (2) is monitored and adjusted to maintain the pH in the alkaline range. For example, by adding an alkali metal base, such as potassium carbonate, to the solvent solution (9). The process (14) also has a temperature control step (3) for controlling the temperature of the absorbing step (2). For example, the solvent solution (9) may be cooled during the absorbing step (2) and/or a side-stream of the solvent solution (9) may be withdrawn from the absorbing step (2) and cooled, and then returned to the absorbing step (2). The temperature of the absorbing step (2), can be controlled by a temperature control step (3) which will be a function of parameters, including the pressure of the gas stream (7), the loading of the solvent solution, the background concentration of the carbonate/bicarbonate solvent, and the performance of the catalytic compound. Ideally, the temperature control step (3) will maintain the absorbing step (2) in the temperature ranging from 40 to 90° C., and suitably to a temperature in the range of 40 to 70° C. The solvent solution discharged from the absorbing step (2) will have a bicarbonate loading, and all the bicarbonate can either remain dissolved which provides the loading, or a portion thereof can be precipitated in a precipitating step (4) to form a slurry. In this situation where the gas stream (7) is at a high pressure and a high temperature, the precipitating step (4) is less likely to be occur than when the gas stream (7) is at a low pressure and low temperature. In any event, the precipitating step (4) may or may not occur, but when it does occur, the precipitating step (4) ideally occurs during the absorbing step (2) in an absorber vessel. The solvent solution (9) and/or a slurry containing bicarbonate precipitant will be fed to a desorbing step (6). The desorbing step (6) includes heating the solvent solution (9) to drive off carbon dioxide which converts bicarbonate to carbonate, thereby producing a carbon dioxide rich gas stream (12) which is discharged from the desorbing step (6) and a lean solvent solution (9) that is lean in carbon dioxide. The desorbing step (6) may also be subject to a further temperature control step (13) that is a function of parameters including the lean loading of the solvent solution feed from the desorbing step (6) to the absorbing step (2), the operating pressure of the desorbing step (6), and background potassium carbonate concentration in the solvent solution. The temperature control step (13) may control the temperature of the desorbing step (6) to a temperature ranging from 70 to 170° C., and suitably from 80 to 170° C., and suitably from 80 to 120° C., and even more suitably from 120 to 150° C.

Portions of the solvent solution (9), including the catalytic compound will be circulated between the absorbing step (2) and the desorbing step (6). Moreover, the catalytic compound is predominantly in a liquid phase of the solvent solution (9) throughout the process (14). That is, catalytic compound will be in the solvent solution independently of the loading of the solvent solution and the degree of precipitation of bicarbonate in the precipitating step (4).

The process (14) may also have a separating step (5) in which the bicarbonate precipitant is separated from the solvent solution (9), and the solvent solution (9) separated from the bicarbonate precipitant can then be fed to either one, or both of, the absorbing step (2) and/or the desorbing step (6). When the solvent solution (9) is fed from the separating step (5) back to the absorbing step (2) bypassing the desorbing step (6), as represented by the curved arrow line form the separating step (5) back to the absorbing step (2) in FIG. 2, additional make up alkali carbonate may be added to the absorbing step (2) to maintain an absorbent concentration and an alkaline pH. The bicarbonate precipitant, separated in the separating step (5), can be accumulated in a storing step (10) and can be used later in the desorbing step (9) and/or used in other application/uses (11), such as manufacturing agricultural fertilizers. The bicarbonate precipitant separated in the separating step (5) can also be fed to the desorbing step (6) with or without storing.

In addition, a sub-stream of the solvent solution (9) can be taken from the desorbing step (6) and/or from other steps of the process (14) and used in other applications/uses (11).

### Trial

A trial was conducted in to compare the performance of solvent solutions containing promoted and unpromoted absorbents. Repeated trials were conducted by sparging a known amount of temperature controlled, water saturated carbon dioxide through an agitated vessel containing known volumes of solvents of different solvent recipes. The solvent vessel was temperature controlled to the same temperature as the sparge gas. Each trial run was continued for up to 90 minutes and the absorption performance measured.

Samples of the solvent solutions were taken for analysis at regular intervals and the amounts of carbon dioxide in the solutions calculated. The CO₂(g) uptake over time for each solvent solution was plotted and compared. The carbon dioxide uptake is indicative of the loading of the solvent which in all cases was sufficiently concentrated to produce a precipitant of bicarbonate.

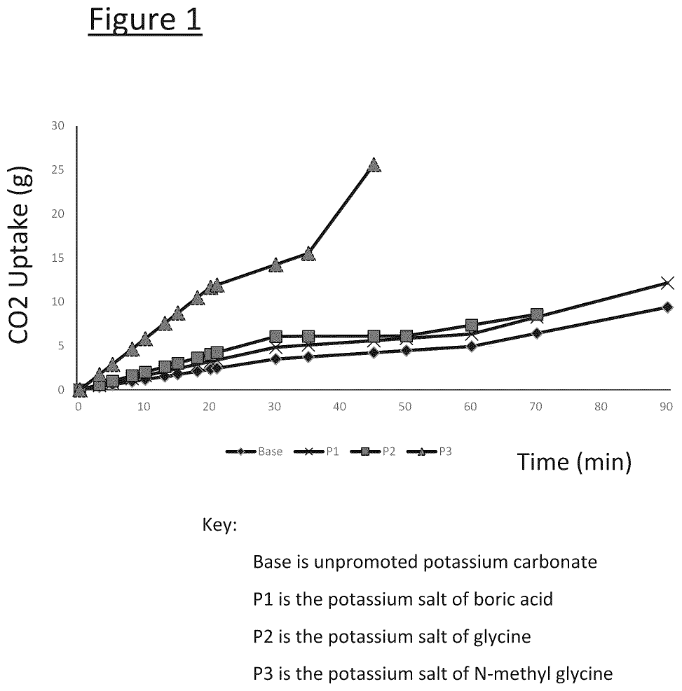

The base solvent comprised an aqueous solution of 45 w/w K₂CO₃. The base solution was unpromoted, and is graphically represent, in FIG. 1 below, as the base. The loading showed a continual increase to ˜40% loading until the test was halted at 90 minutes. Two alternative first-generation promoters P1 (potassium salt of boric acid), and P2 (potassium salt of glycine), were added to fresh carbonate solvent solutions and the trials were repeated. The trials were conducted for 90 and 70 minutes respectively and the loading analysed and graphical represent.

Similarly, the preferred promoter, P3 (the potassium salt of N-methyl glycine) graphically represent, in FIG. 1 below, as the blue lines was added to a fresh solvent solution, and the trial repeated. This showed significantly increased kinetics over an extended period. This showed higher absorption rates than the other promoters and that higher rate continued even as the loading of the solution increased.

Successive repeats of all the experiments validate the findings shown in FIG. 1.

The CO₂(g) uptake of P1 and P2 initially showed improved absorption rate over the base solvent however this plateaued out at a level consistent with the concentration of the promoter, showing that the kinetic improvement in these cases were the result of the promoter being converted to a state requiring thermal regeneration. In the case of P2, glycine this state is the carbamate.

However, the P3 promoter surprisingly continued to show higher absorption kinetics well beyond the point of the imputed conversion to the maximum carbamate species possible. This exhibited the unexpected catalytic effect resulting from the unstable carbonate, high carbonate base concentration and precipitation allowing the persistent high rate catalytic performance of the types of promoters claimed herein.

Those skilled in the art of the present invention will appreciate that many variations and modifications may be made to the preferred embodiment without departing from the spirit and scope of the present invention.

1. An aqueous solvent solution that absorbs carbon dioxide and produces a bicarbonate, the solvent solution includes:
i) at least one base that is dissolved in water; and
ii) a catalytic compound dissolved in the water, wherein the catalytic compound is an alkali salt of an N-substituted amino acid that reacts with carbon dioxide to form a catalytic intermediate having a carbamate group, and the catalytic intermediate reacts with a base which deprotonates the carbamate and undergoes hydrolysis which removes a carbonate group from the catalytic intermediate and yields a bicarbonate precipitant.

2. The aqueous solvent solution according to claim 1, wherein the base deprotonates the carbamate of the intermediate catalyst and which then undergoes hydrolysis to hydrolyse the carbonate group, yielding bicarbonate and reforming the catalytic compound.

3. The aqueous solvent solution according to claim 1, wherein the base is at a high concentration in the aqueous solution so that the bicarbonate precipitates as a salt with the base.

4. An aqueous solvent solution that absorbs carbon dioxide and produces a bicarbonate, in which the solvent solution includes:
i) at least one base that is dissolved in water; and
ii) a catalytic compound dissolved in the water, wherein the catalytic compound is an alkali salt of an N-substituted amino acid that reacts with carbon dioxide to form an intermediate catalyst having a carbamate group which then reacts with the base to deprotonate the carbamate group of the intermediate catalyst and which then undergoes hydrolysis to hydrolyse the carbonate group, yielding bicarbonate and reforming the catalytic compound; and
iii) wherein the base is at a high concentration in the aqueous solution so that the bicarbonate precipitates as a salt with the base.

5. The aqueous solvent solution according to claim 1, wherein the base for the catalytic compound has the general formula:
M⁺⁻OOC(CHR²)HNR¹ (Formula 1)
wherein
R¹ is a group having at least one C atom,
R² is H or a group having at least one C atom, and
M⁺ is an alkali metal.

6. The aqueous solvent solution according to claim 5, wherein the catalytic compound is N-alkyl amino acid, where R¹ is an alkyl group and R² is any group having at least one C atom.

7. The aqueous solvent solution according to claim 5, wherein the catalytic compound is N-methyl amino acid, where R¹ is a methyl group and R² is any group having at least one C atom.

8. The aqueous solvent solution according to claim 5, wherein the catalytic compound is N-methyl glycine in which R¹ is a methyl group and R² is H.

9. The aqueous solvent solution according to claim 5, wherein the catalytic compound is N-methyl alanine, in which R² is a methyl group and R¹ is a methyl group.

10. The aqueous solvent solution according to claim 5, wherein the catalytic compound is n-methyl serine, in which R² is a methyl group and R¹ includes a methyl hydroxyl (MeOH) group.

11. The aqueous solvent solution according to claim 1, wherein the at least one base dissolved in water is an alkali metal of varying levels of carbonation.

12. The aqueous solvent solution according to claim 11, wherein the at least one base dissolved in water is potassium alkali including KOH having a zero level of carbonation, K₂CO₃ having a 2:1 ratio of carbonation, and KHCO₃ having a 1:1 ratio of carbonation.

13. The aqueous solvent solution according to claim 1, wherein:
the solvent solution has potassium carbonate in the range of 10 to 80 wt %, suitably 20 to 70 wt %, and suitably 30 to 60 wt %; or
the solvent solution has a pH greater than 8.0, and suitably greater than 9.0, and even more suitably a pH in the range of 9.0 to 13.5.

14. (canceled)

15. A process of absorbing carbon dioxide from a gas stream, the process includes:
(i) an absorbing step, in which the gas stream and the aqueous solvent solution according to claim 1 contact in an absorber vessel so that carbon dioxide in the gas stream reacts with the amino acid derivative of the solvent solution and adds a carbonate group to the amino group of the amino acid derivative to form a catalytic intermediate having a carbamate, wherein the absorbing step is carried out under alkaline conditions so that the catalytic intermediate deprotonates and the carbamate group undergoes hydrolysis which produces a bicarbonate and regenerates the amino acid derivative; and
(ii) a precipitating step, in which the bicarbonate precipitates as an alkali bicarbonate precipitant.

16. The process according to claim 15, wherein the process includes a temperature control step that includes cooling the solvent solution during the absorbing step.

17. The process according to claim 16, wherein the temperature control step includes either one or a combination of: cooling the solvent solution in situ in an absorbing vessel during the absorbing step; and/or withdrawing a side-stream of the solvent solution from absorbing step, cooling the side stream, and returning the side-stream back to the absorbing step.

18. The process according to claim 15, wherein:
the process includes providing the solvent solution with adequate base to deprotonate the amino acid derivative; or
the process includes monitoring the pH of the solvent solution at a level greater than 8.0, and suitably greater than 9.0 and suitably in a pH range of 9.5 to 13.5; or
the process includes adjusting the pH of the solvent solution by adding an alkali metal base; or
the process includes a separating step, in which the alkali bicarbonate precipitant is separated from the solvent solution and the solvent solution is recycled back to the absorbing step; or
the process includes a desorbing step in which bicarbonate is converted to carbonate using a heat source and, forming a gas stream rich in carbon dioxide; or
the gas stream is a post combustion gas stream.

19. (canceled)

20. (canceled)

21. (canceled)

22. (canceled)

23. (canceled)

24. The process according to claim 15, wherein:
the process includes a temperature controlling step that controls the temperature of the absorbing step to a temperature ranging from 40 to 95° C.; or
the process includes a temperature control step that controls the temperature of the desorbing step to a temperature ranging from 70° to 170° C.

25. (canceled)

26. The process according to claim 15, wherein:
the absorbing step is carried out at a pressure ranging from 100 to 1000 kPa absolute; or
the absorbing step is carried out at a pressure ranging from 100 kPa to 150 kPa absolute.

27. (canceled)

28. The process according to claim 15, wherein the gas stream is a high pressure gas stream including, but not limited to, a pre-combustion gas stream, and the absorbing step is carried out at a pressure ranging from 1,000 to 8,000 kPa absolute, and suitably at a pressure ranging from 2,500 to 6,500 kPa absolute.
